(19) United States
(12) Patent Application Publication
(10) Pub. No.: US 2005/0154656 A1
(43) Pub. Date: Jul. 14, 2005

(54) Ranking comparable properties for appraisal

(76) Inventors: Christopher D. Y. Kim, Littleton, CO (US); Charles J. Gadd, Littleton, CO (US); Andrea Cope, Littleton, CO (US); Santiago Silva, Littleton, CO (US); Richard P. Li, Denver, CO (US)

Correspondence Address: HENSLEY KIM & EDGINGTON, LLC, 1660 LINCOLN STREET, SUITE 3050, DENVER, CO, 80264, US

(21) Appl. No.: 11/034,238

(22) Filed: Jan. 12, 2005

Related U.S. Application Data
(60) Provisional application No. 60/536,107, filed on Jan. 12, 2004.
(60) Provisional application No. 60/536,111, filed on Jan. 12, 2004.
(60) Provisional application No. 60/536,137, filed on Jan. 12, 2004.
(60) Provisional application No. 60/536,106, filed on Jan. 12, 2004.

(51) Int. Cl. G06F 17/60

(52) U.S. Cl. 705/30; 705/19

(57) ABSTRACT

In support of an appraisal process, comparable properties are ranked using an algorithmic approach that considers multiple property characteristics of multiple properties to find and order the most similar properties to a subject property. In one implementation, a deterministic linear dissimilarity algorithm is used to compare multiple characteristics of multiple properties, relative to a subject property. An appraiser can also weight various characteristic categories to emphasize features the appraiser believes to be most important in the appraisal. The appraiser can therefore customize the weightings associated with such property characteristic categories to reflect local valuation relationships.

### RELATED APPLICATIONS

The present application claims benefit of U.S. Provisional Patent Application No. 60/536,107, entitled “Condition Score Appraisal”; U.S. Provisional Patent Application No. 60/536,111, entitled “Methods and Systems for Ranking Comparable Properties for Property Appraisals”, U.S. Provisional Patent Application No. 60/536,137, entitled “Comparables Display Page for Use in Validation”, and U.S. Provisional Patent Application No. 60/536,106, entitled “Data Clustering for Appraisal Valuation”, all filed on Jan. 12, 2004 and specifically incorporated by reference herein for all that they disclose and teach.

The present application is also related to U.S. patent application Ser. No. ______ [Attorney Docket No. 236-002-USP], filed Jan. 12, 2005 and entitled “Condition Scoring for a Property Appraisal System”, specifically incorporated by reference herein for all that it discloses and teaches.

### TECHNICAL FIELD

The invention relates generally to property appraisal systems, and more particularly to ranking comparable properties in a real estate property appraisal system.

### BACKGROUND

Generally, an appraiser attempts to judge the value of a given real estate property using a variety of objective and subjective characteristics of the property. Some exemplary objective characteristics may include without limitation the location of the property, the size of the property, and the square footage of any structures on the property. A typical appraisal involves selecting recently-sold properties having characteristics similar to those of the subject property and using the recent sales prices of these “comparable” properties to set a value for the subject property.

Typically, an appraiser selects a subset of comparable properties filtered out of all available comparable properties in order to estimate the value of a subject property. This filtering process generally requires an appraiser to incrementally select a few of the most similar properties from the overall set of properties. For example, the appraiser may first filter out properties that are considered geographically too far away from the subject property, then filter out properties that are not of the same style (e.g., ranch, two story, split level, detached garage), then filter out properties based on the age of the home, etc. In the end, the appraiser is left with a small subset of comparable properties from which he or she can estimate a value for the subject property using standard appraisal procedures.

However, the incremental filtering described above frequently does not result in the best subset of comparable properties. For example, a split level comparable may be a reasonable selection to compare to a two story subject, if most other characteristics are very similar, but using the typical incremental filtering process the split level property may be filtered out in an early stage of the filtering procedure. Furthermore, absent this incremental filtering approach, judging how closely a given comparable property compares to a subject property in the presence of multiple property characteristics (e.g., square footage, acreage, features, locations, price, etc.) is a complex yet subjective process itself. It is difficult to consistently consider and evaluate so many variables for a large number of potentially comparable properties. (In fact, in many circumstances, an appraiser may limit the initial number of properties considered in order to reduce the difficulty in this evaluation.) Accordingly, appraisal results are therefore less consistent and less accurate across many properties than is desirable.

### SUMMARY

Implementations described and claimed herein address the foregoing problems by ranking comparable properties using an algorithmic approach that considers multiple characteristics of multiple properties to find the most similar properties to a subject property. In one implementation, a deterministic linear dissimilarity algorithm is used to compare multiple characteristics of multiple properties, relative to a subject property, although other methods may be used. By its deterministic nature, the algorithm complies with standard appraisal procedures. Furthermore, such an algorithm allows a large number of initial properties to be considered without difficulty.

Furthermore, in some implementations, an appraiser can apply weighting factors to various characteristic categories to emphasize features the appraiser believes to be most important in the appraisal. For example, in a given geographical area, an appraiser may believe that a city view has a strong positive influence on the valuation of a property, whereas air conditioning is less important. The appraiser can therefore customize the weightings associated with such property characteristic categories to reflect these relationships.

In some implementations, articles of manufacture are provided as computer program products. One implementation of a computer program product provides a computer program storage medium readable by a computer system and encoding a computer program. Another implementation of a computer program product may be provided in a computer data signal embodied in a carrier wave or other communication media by a computing system and encoding the computer program.

The computer program product encodes a computer program for a computer process executing on a computer system. The computer process executes a computer process for ranking a plurality of comparable real estate properties relative to a subject real estate property in an appraisal process. Scores associated with characteristic categories of the subject real estate property and of each comparable real estate property are received. A dissimilarity measure is computed in each characteristic category for each comparable real estate property. The dissimilarity measures associated with individual comparable real estate property are aggregated to generate a ranking score associated with the comparable real estate property. The comparable real estate properties are ordered according to the ranking scores of the comparable real estate properties.

In another implementation, a method ranks a plurality of comparable real estate properties relative to a subject real estate property in an appraisal process. Scores associated with characteristic categories of the subject real estate property and of each comparable real estate property are received. A dissimilarity measure is computed in each characteristic category for each comparable real estate property. The dissimilarity measures associated with individual comparable real estate property are aggregated to generate a ranking score associated with the comparable real estate property. The comparable real estate properties are ordered according to the ranking scores of the comparable real estate properties.

In another implementation, an appraisal system ranks a plurality of comparable real estate properties relative to a subject real estate property in an appraisal process. The system provides means for receiving scores associated with characteristic categories of the subject real estate property and of each comparable real estate property, means for computing a dissimilarity measure in each characteristic category for each comparable real estate property, means for aggregating the dissimilarity measures associated with individual comparable real estate property to generate a ranking score associated with the comparable real estate property, and means for ordering the comparable real estate properties according to the ranking scores of the comparable real estate properties.

In yet another implementation, a system ranks a plurality of comparable real estate properties relative to a subject real estate property in an appraisal process. A database receives real estate property data relating to the comparable real estate properties. A scoring module computes scores associated with characteristic categories of the subject real estate property and of each comparable real estate property based on the real estate property data received by the database. A dissimilarity module computes a dissimilarity measure in each characteristic category for each comparable real estate property. An aggregation module combines the dissimilarity measures associated with individual comparable real estate property to generate a ranking score associated with the comparable real estate property. A ranking module orders the comparable real estate properties according to the ranking scores of the comparable real estate properties.

Other implementations are also described and recited herein.

### BRIEF DESCRIPTIONS OF THE DRAWINGS

FIG. 1 illustrates an exemplary system for providing property appraisals using subjective property characteristics.

FIG. 2 illustrates a login page of an exemplary appraiser valuation engine.

FIG. 3 illustrates a property identification page of an exemplary appraiser valuation engine.

FIG. 4 illustrates a portion of a condition and weighting page of an exemplary appraiser valuation engine.

FIG. 5 illustrates another portion of a condition and weighting page of an exemplary appraiser valuation engine.

FIG. 6 illustrates yet another portion of a condition and weighting page of an exemplary appraiser valuation engine.

FIG. 7 illustrates a portion of a comparable property page of an exemplary appraiser valuation engine, the page portion showing a map that marks locations of the comparable properties and a subject property.

FIG. 8 illustrates another portion of a comparable property page of an exemplary appraiser valuation engine, the page showing a portion of a top-ranked comparable properties list.

FIG. 9 illustrates another portion of a comparable property page of an exemplary appraiser valuation engine, the portion showing another portion of a top-ranked comparable properties list.

FIG. 10 illustrates yet another portion of a comparable property page of an exemplary appraiser valuation engine, the page showing a portion of an alternative comparable properties list,

FIG. 11 illustrates yet another portion of a comparable property page of an exemplary appraiser valuation engine, showing a portion of an alternative comparable properties list.

FIG. 12 illustrates a portion of an estimated value page of an exemplary appraiser valuation engine.

FIG. 13 illustrates another portion of an estimated value page of an exemplary appraiser valuation engine.

FIG. 14 illustrates operations of an exemplary appraiser valuation engine.

FIG. 15 illustrates an exemplary system useful in implementations of the described technology.

### DETAILED DESCRIPTIONS

The property appraisal process is typically based on numerous characteristic categories of the property being appraised as well as the relative importance of those characteristics to the value of the property. During an appraisal, an appraiser attempts to track many property characteristics as well as some subjective level of importance associated with those property characteristics. In addition, the appraiser attempts to consistently apply property characteristic assessments across perhaps many comparable properties in order to appraise a property. The large number of property characteristics, various importance levels, and comparable properties, as well as the relatively subjective nature of the characteristics and importance levels can render the appraisal process an extremely difficult task. An exemplary appraisal valuation engine described herein can numerically rank comparable properties using a deterministic function of characteristic scores and weighting factors to characterize the relative importance of the associated characteristics.

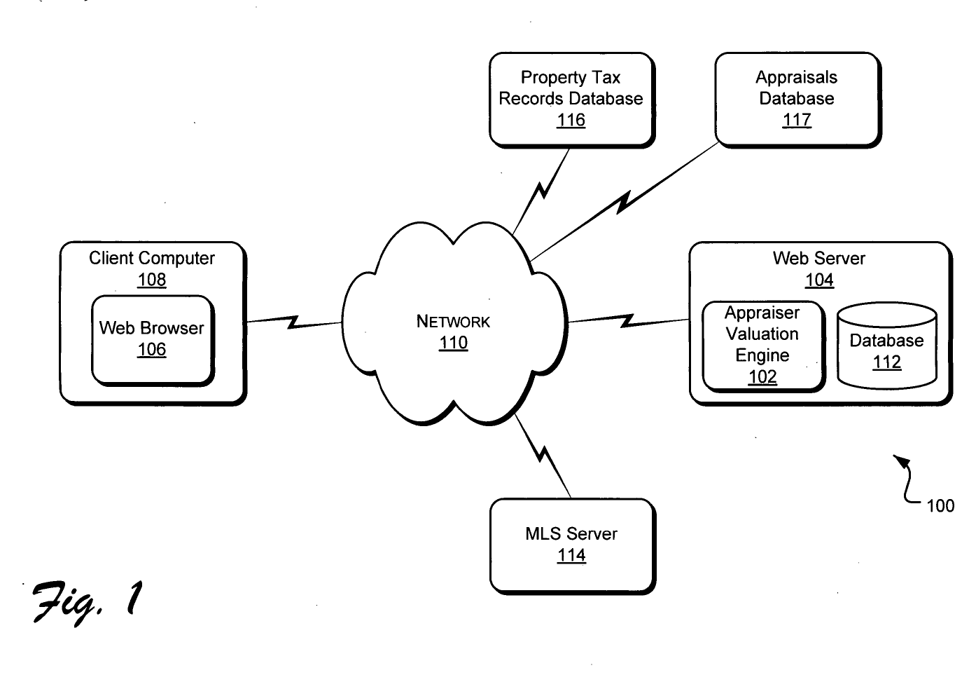

FIG. 1 illustrates an exemplary system 100 for providing property appraisals using subjective property characteristics. In the illustrated implementation, an appraiser valuation engine 102 resides on a web server 104 and accesses an appraisal system database 112. In an exemplary scenario, an appraiser will access the appraiser valuation engine 102 across a communications network 110 using a web browser 106 on a client computer 108. However, alternative implementations are contemplated, including non-web-based solutions and configurations where the user accesses an appraiser valuation engine that is resident on the client computer, rather than on a server computer.

The appraisal valuation engine 102 has access to property information, such as information available from a Multiple Listing Service (MLS) server 114, property tax records databases 116, and appraisals databases 117, although other property information sources may also be employed. Subject property data may be retrieved from these databases. In one implementation of the described system, the comparable property data is also available from the remote databases and is periodically (e.g., nightly) downloaded, “cleaned”, and stored in the appraisal system database 112. Alternatively, or in addition, comparable property data may be downloaded responsive to a request from a user and stored at that time in the appraisal system database 112.

When using the system 100 in the illustrated scenario, the appraiser is attempting to determine an accurate value of a subject property. One stage of this valuation process is to find reference properties with characteristics that are “comparable” to those of the subject property. Valuation judgments about the subject property can then be based on characteristics of these comparable properties, such as recent sale prices.

As such, the appraiser accesses the appraiser valuation engine 102 and inputs information that identifies the subject property, such as the property's address. Given the identification information about the subject property, the appraiser valuation engine 102 may access one or more property information sources (e.g., 112, 114, 116, and/or 117) to obtain relevant real estate property data, such as MLS data, tax assessment data, previous sale data, previous appraisal data, etc. In addition, the appraiser valuation engine 102 may retrieve real estate property data for potentially comparable properties from the same sources. Generally, the real estate property data for both the subject property and the potentially comparable properties includes both objective property characteristics and subjective property characteristics.

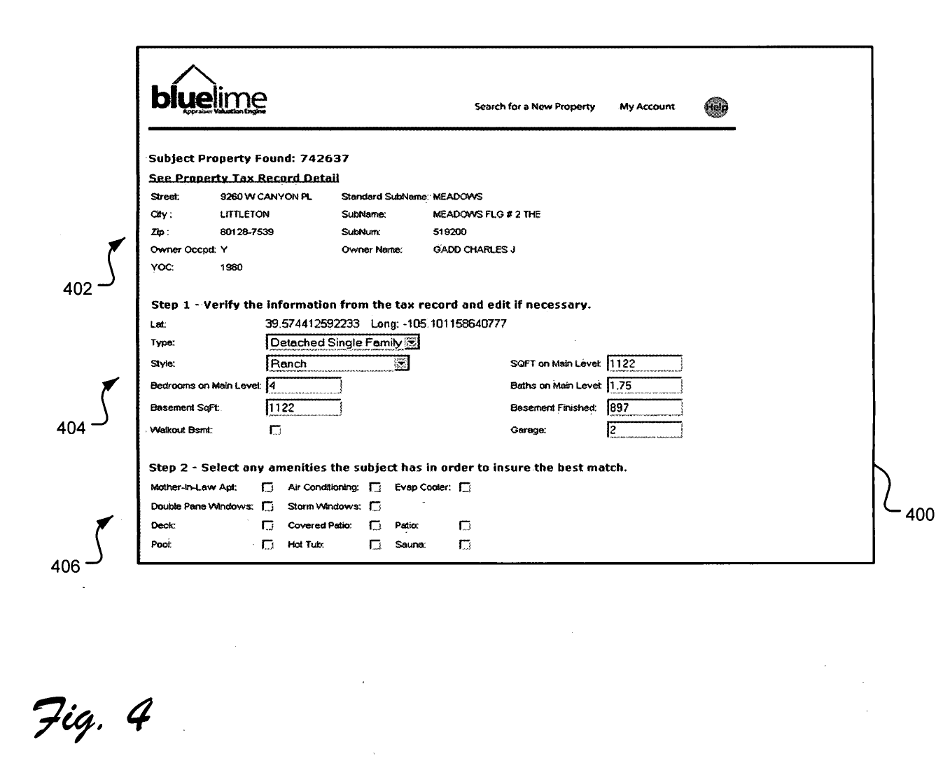

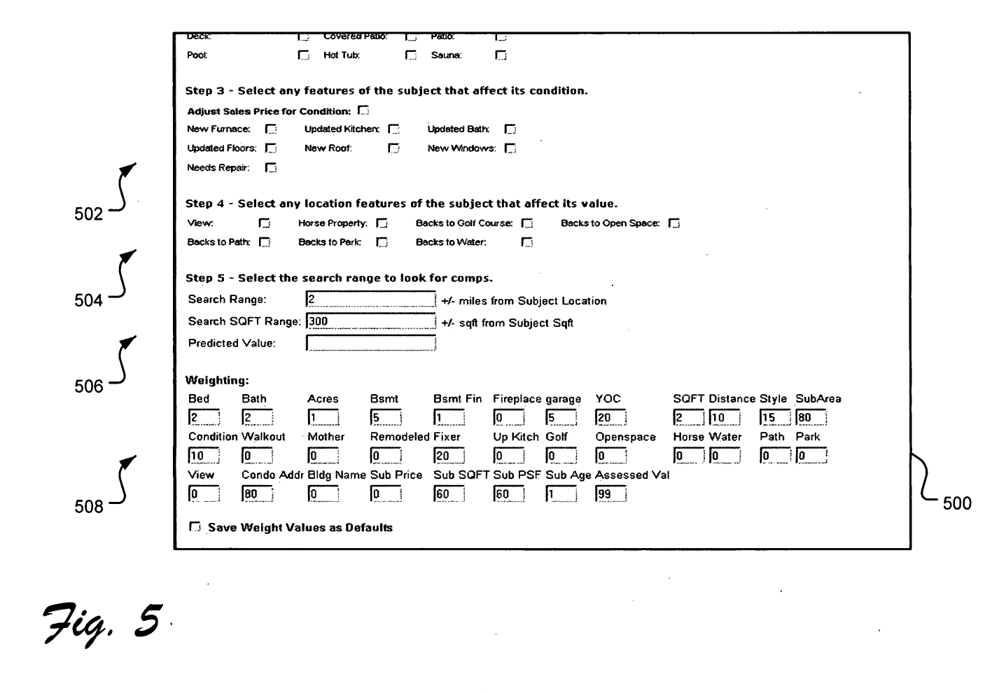

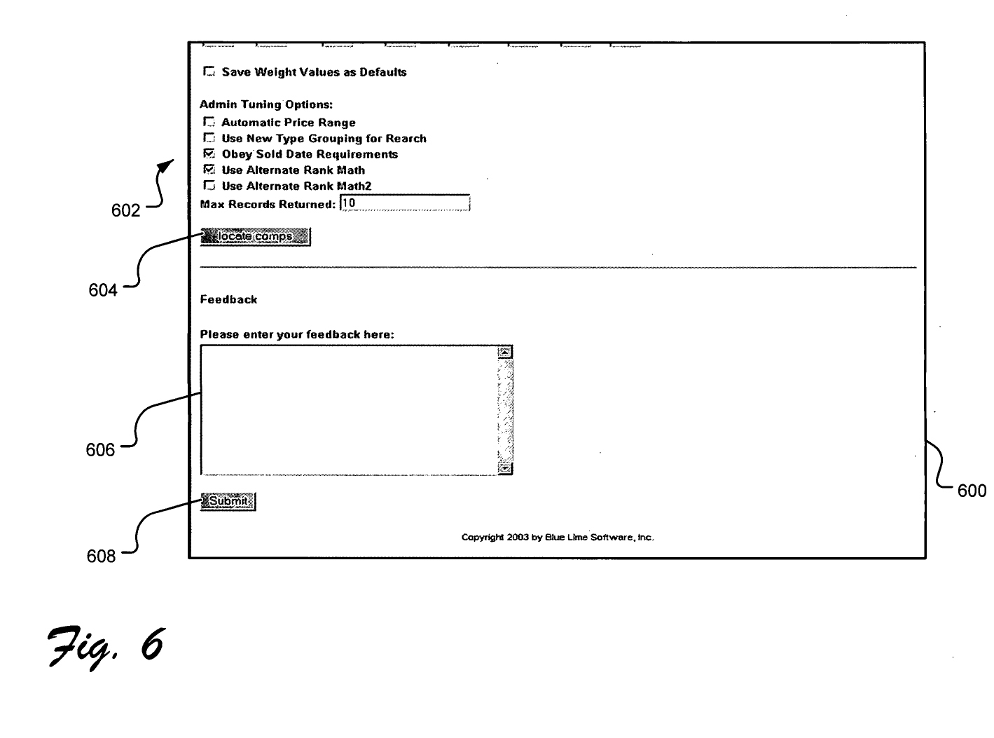

The appraiser may add additional characteristics to the profile of the subject property data to improve the description of the property and thereby improve the retrieval of more similar reference properties. Examples of such additional characteristics are displayed in a Condition and Weighting Page in the web browser 106. See, for example, the page portions 400 in FIG. 4, 500 in FIG. 5, and 600 in FIG. 6. The appraiser is then prompted to enter additional information, including special amenities, such as “Pool” or “Storm Windows”, condition characteristics, such as “Needs Repair” and “Updated Bathroom”, location features, such as “View” or “Horse Property”, and other characteristics (all of which may be considered to have subjective “condition” characteristics for the purposes of this description). These additional characteristics may be used individually or may be combined and converted into a composite condition score, which may be used in identifying comparable properties.

It should be understood that these additional characteristics may vary from implementation to implementation of an appraiser valuation engine 102, and from region to region. For example, anticipated condition characteristics in New York City may vary from those in Denver. As such, an appraisal valuation engine for use in Manhattan may omit a “Horse Property” selection, while an appraisal valuation engine for use in Denver may omit a “Near Subway” selection.

Having scored the characteristics of the subject property and the comparable properties, the potential comparable properties are ranked according to a variety of objective property characteristics, which now includes the composite condition score. The “most” comparable properties are identified as the “comparable” properties (or the “comps”) for the subject property, although the appraiser may replace one or more of these properties with other, initially lower-ranking properties using the user interface. The resulting comparable properties are then analyzed by the appraiser valuation engine 102 to generate a proposed value for the subject property.

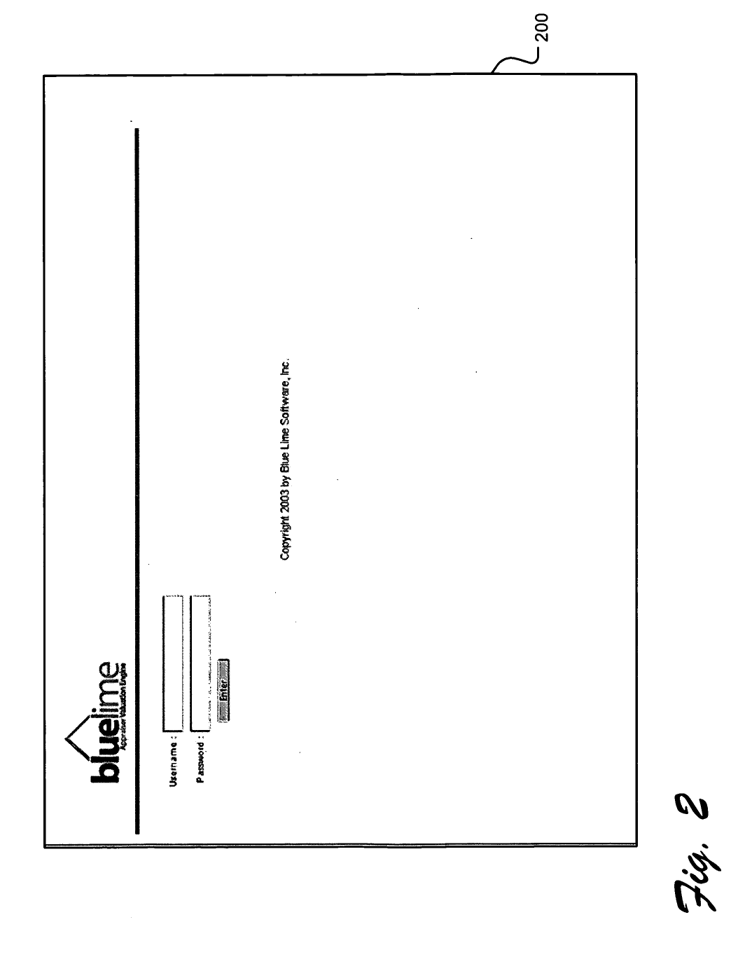

FIG. 2 illustrates a login page 200 of an exemplary appraiser valuation engine. The login page 200 includes a name field and a password field in which a user (e.g., an appraiser) enters his/her name and password to access the appraiser valuation engine. Having entered the login information, the user can select an “enter” button on the login page 200 to gain access to the appraiser valuation engine.

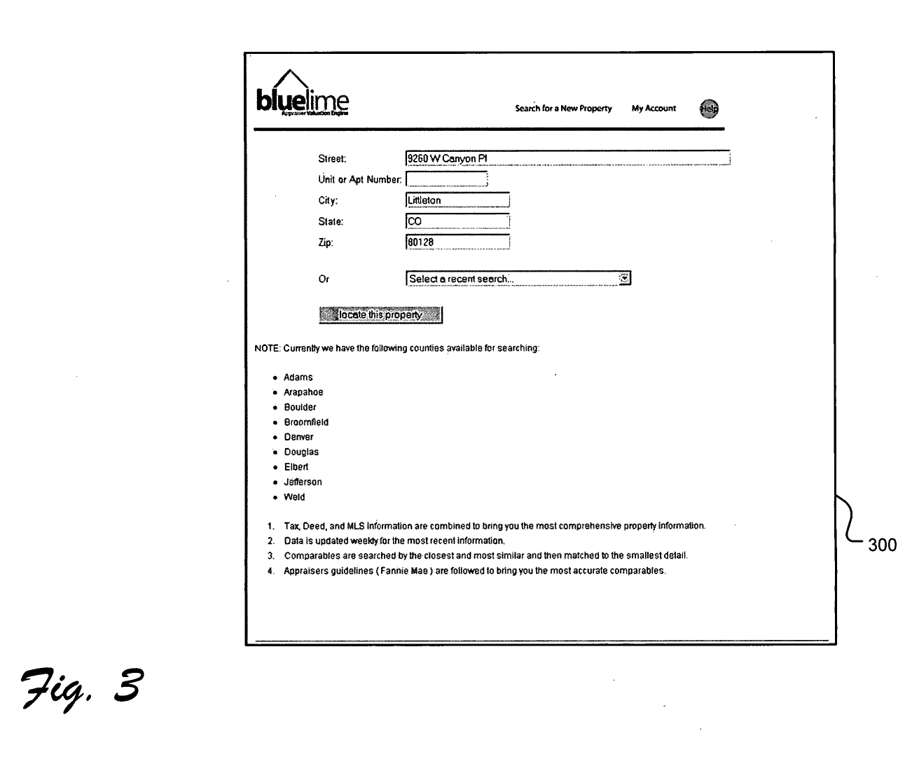

FIG. 3 illustrates a property identification page 300 of an exemplary appraiser valuation engine. The user can enter identification information about the subject property (i.e., the property being appraised), such as an address, although other identification information may be used (e.g., a previous search identifier, a computer-generated unique identifier, or a user-specified name or identifier).

After the user identifies the subject property, the user selects a “locate” button. The identification data is then sent to the appraiser valuation engine, which locates the subject property in one or more property data sources, such as an appraisal system database or remote data sources, such as an MLS database. If the subject property is not found, an error may be issued to the user, telling the user that the subject property was not located. If the subject property is located, the appraiser valuation engine generates a condition and weighting page, such as the page portions 400, 500, and 600 shown in FIGS. 4, 5, and 6, so that the user can continue with the appraisal process. The user may also select another recent search, for which comparable property results have already been processed.

FIG. 4 illustrates a portion of a condition and weighting page 400 of an exemplary appraiser valuation engine. A subject property identification information section 402 includes the subject property address, owner name, year of construction (YOC), sub-division information, and other characteristics. The subject property identification information section 402 can also include one or more hyperlinks that will take the user to pages displaying additional tax, deed, and MLS information. In a tax information edit section 404, one or more fields contain data retrieved from a tax record database (e.g., Property Data Center (PDC)), which the user may verify and, if necessary, correct. An amenities selection section 406 includes one or more fields in which the user can enter property amenities of interest, such as “air conditioning”, “storm windows”, and other characteristics. In some implementations, these amenity selections may be used as condition data for the subject property.

FIG. 5 illustrates another portion 500 of a condition and weighting page of an exemplary appraiser valuation engine. A condition selection section 502 includes one or more fields in which the user can enter property conditions of interest, such as “kitchen updated”, “new furnace”, and others. A location selection section 504 includes one or more fields in which the user can specify any location features of interest, such as “view”, whether the property backs to open space, and other characteristics. A range selection section 506 includes one or more fields whereby the user may choose the scope of the comparable search in terms of geographic range, square-footage, and other characteristics, relative to the subject property.

A weighting entry section 508 includes weighting fields in which a user can set weighting factors associated with each of the property attributes of interest. The weighting values correspond to the level of importance the user associates with each of the property attributes. Thus, the user is able to assign weighting factors, or importance values, on property attributes that can be used to rank comparable properties and value the subject property. In one implementation, a larger weight implies that the associated attribute is of more importance, although other relationships may be employed.

Weighting factors are useful in customizing the appraisal “comp” results in accordance with a particular appraiser's personal knowledge and style, a particular locale, a particular time period, etc. For example, when identifying appropriate comparable properties to a lake front property, the appraiser will typically need to find at least one lake front property to develop an acceptable valuation. However, if no lake front properties had sold in the recent past or in the immediate geographic proximity to the subject property, the appraiser may choose to increase the weighting factor on the category reflecting whether the property is on the lake front and to decrease the weighting factors on time and/or proximity. In this manner, the appraiser can influence the ranking based on special considerations or knowledge.

FIG. 6 illustrates yet another portion 600 of a condition and weighting page of an exemplary appraiser valuation engine. An administrative section 602 includes checkboxes related to various administrative options for tuning the appraisal process. The tuning option “automated price range” refers to the implementation of a method that requires a maximum allowable price difference of +/−20% between the sale prices of the top three comparable properties chosen by the program. In other words, with “automated price range” selected, the program will not allow the sale prices of any two of the top three comparable properties to differ by more than +/−20%. The program may replace any or all of the top comparable properties with another comparable if the +/−20% price difference requirement is violated. If “automated price range” is not selected, the program will select the top three comparable properties based on their similarity to the subject property and other requirements, but with no regard for the price difference between the top three comparable properties. The tuning option “obey sold date requirements” refers to the implementation of a method that requires the sale dates of the top three comparable properties chosen by the program to meet certain requirements. In one implementation, when “obey sold date requirements” selected, the program requires that at least two of the three top comparable properties have sold dates less than 6 months from the current date. One of the three top comparable properties may have a sold date up to a year from the current date.

A selectable “locate comps” button 604, when selected by the user, causes the property data entered in the fields for the page to be sent to the appraiser valuation engine as a request for identification and ranking of comparable properties. A feedback field 606, in combination with a “submit” button 608, can be used to submit user comments or other feedback about the page to the service vendor maintaining the appraiser valuation engine.

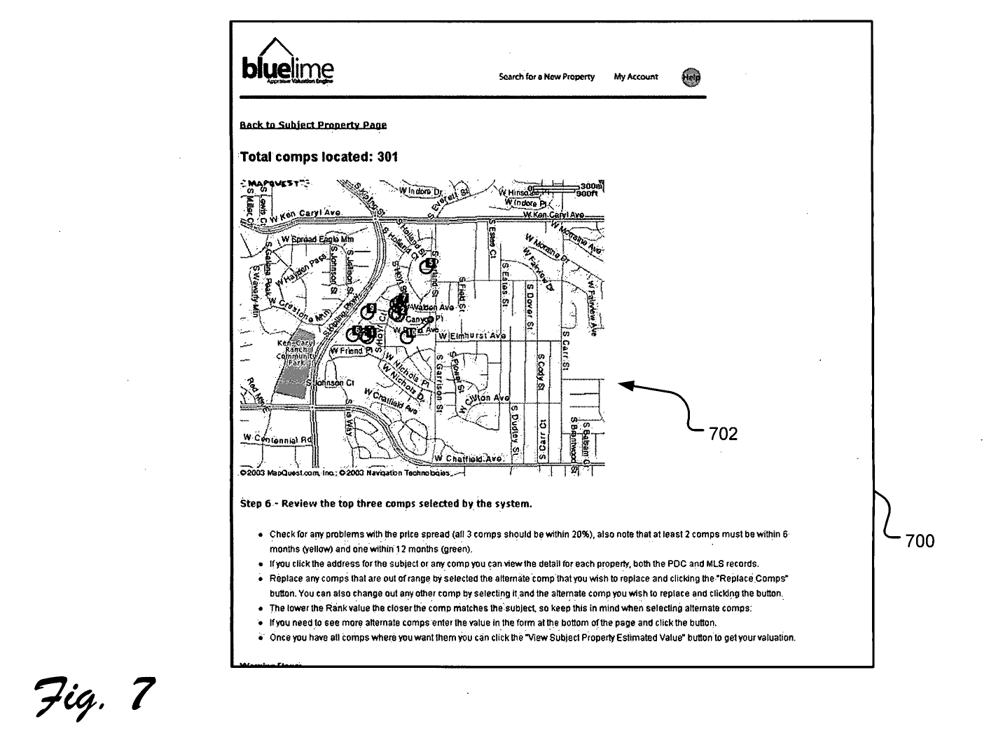

FIG. 7 illustrates a portion 700 of a comparable property page of an exemplary appraiser valuation engine, the page portion 700 showing a map 702 that marks locations of the comparable properties and a subject property. An appraiser valuation engine can generate the map 702 and present the map 702 to the user over a network.

In one implementation, the numerals annotating each property indication on the map 702 represent the rankings of the associated properties in the ranked comparable property list. This feature provides important feedback to the appraiser. For example, if the appraiser finds that the highest ranking comparable property is located across an interstate from the subject property, the appraiser may decide that the property should be omitted from the selected comparable properties used in the valuation. As such, the appraiser can adjust the selection (e.g., using the “replace” feature discussed below) to obtain a better selection of comparable properties.

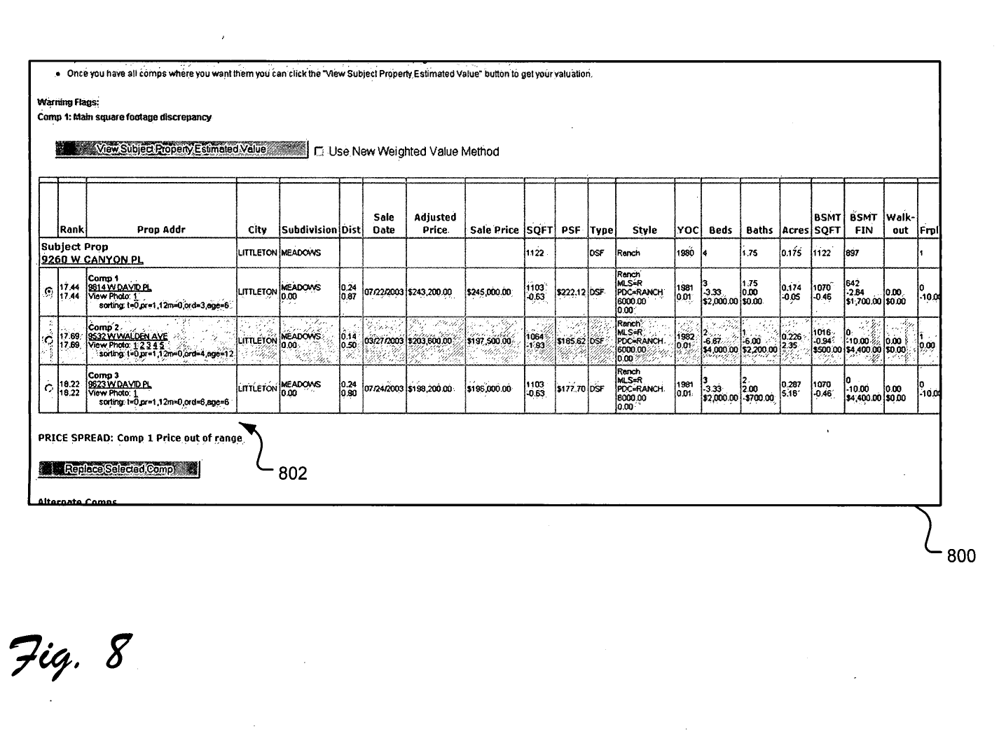

FIG. 8 illustrates another portion 800 of a comparable property page of an exemplary appraiser valuation engine, the page showing a portion of a top-ranked comparable properties list. The portion 800 includes a list 802 of comparable properties showing comparable property data elements and rank. The user may request an estimated value based on the shown comparable properties by selecting a “view subject property estimated value” button. The user may request that the value estimation be performed using a weighted value method by selecting a checkbox. The user may select a comparable property from the list 802 and request that one of the selected top three comparable properties be replaced by an alternate comparable property by selecting the “replace” button. This feature allows the user to adjust the selection of the comparable properties.

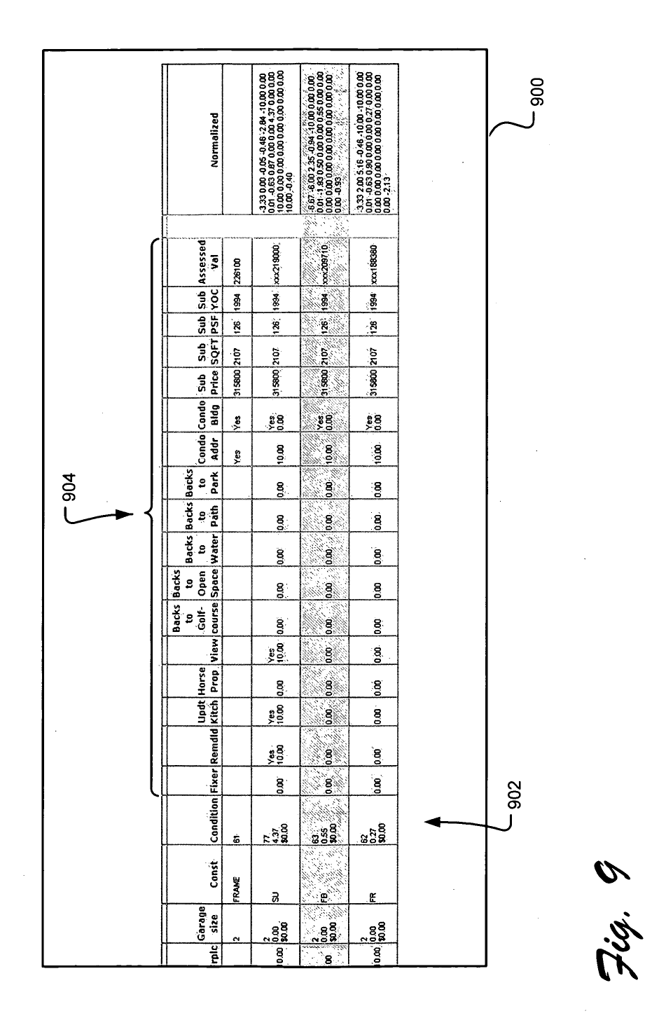

FIG. 9 illustrates another portion 900 of a comparable property page of an exemplary appraiser valuation engine, the portion showing another portion of a top-ranked comparable properties list. The portion 900 is an extension of the page portion 800 from FIG. 8. Thus, each row shown in FIG. 9 is corresponds to one of the comparable properties in the list 802 of FIG. 8. Of particular relevance in the portion 900 is the column labeled “condition” 902. The condition column 902 includes a condition score (e.g., a composite condition score) associated with each of the comparable properties. Specific condition categories that were analyzed to determine the condition scores are shown in columns 904.

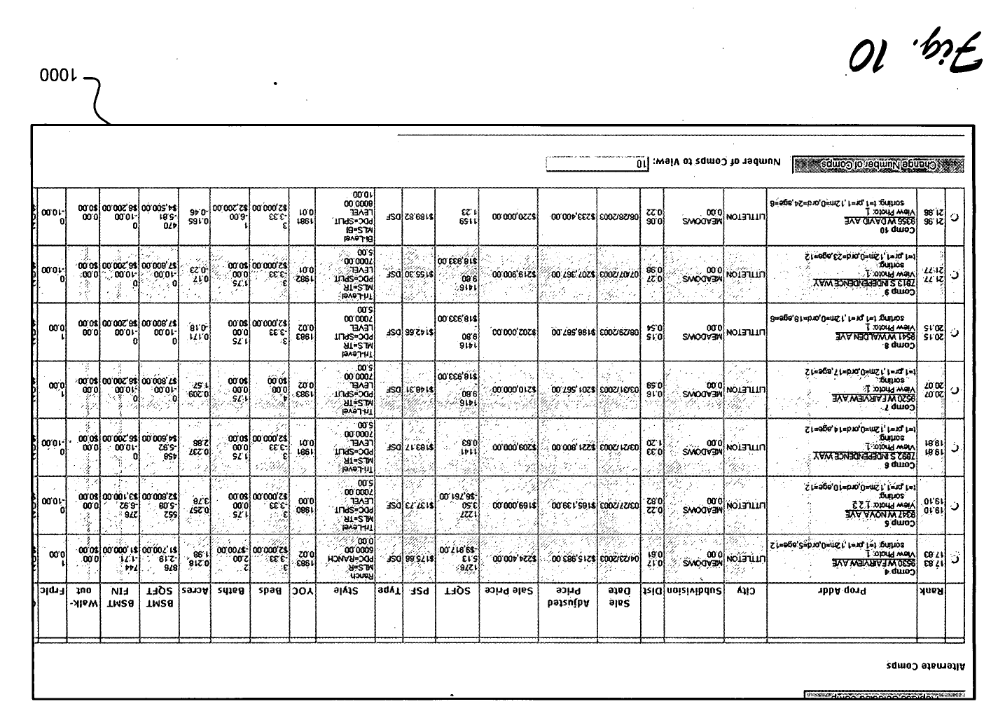

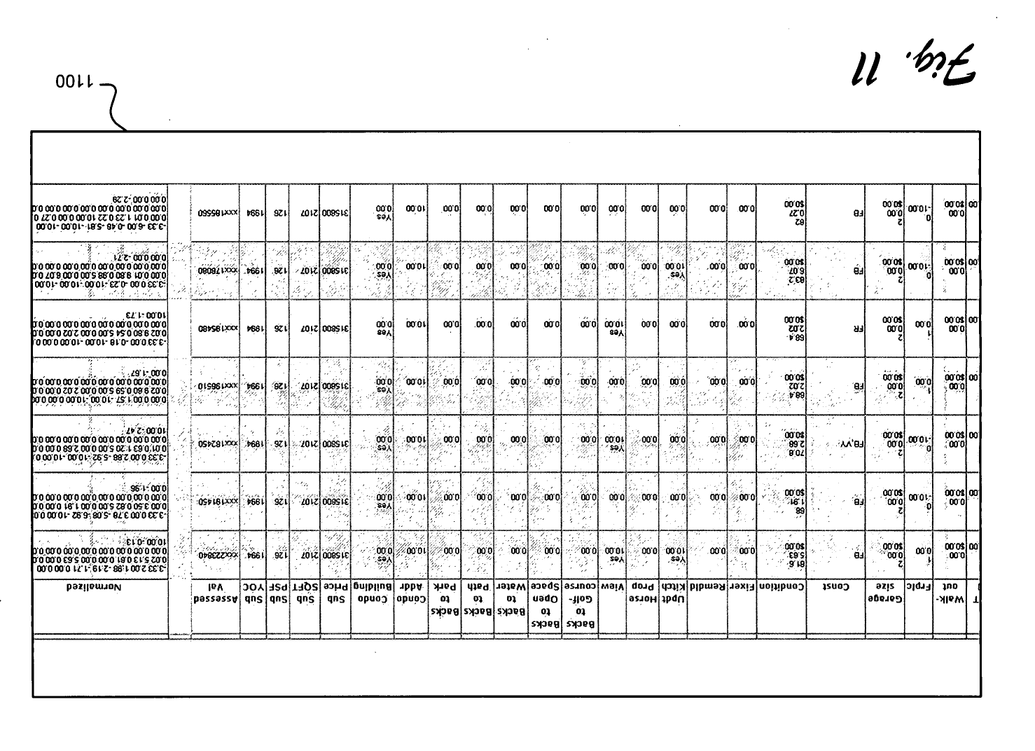

FIGS. 10 and 11 illustrate two other portions 1000 and 1100 of an exemplary comparable property data page wherein the portions include a list 1002 of alternate comparable property data showing comparable property attributes, including conditions and rank. The data shown in page portions 1000 and 1100 are analogous to the data shown in FIGS. 8 and 9, except that the data shown in FIGS. 10 and 11 pertain to alternate comparable properties. As mentioned above with regard to FIG. 8, the user may replace any of the comparable properties shown in the list 802 with an alternative comparable property shown in the list 1002 in FIG. 10. The page portion 1000 also includes a “change number” button, by which the user may change the number of comparable properties that are displayed in the top-ranked comparable properties list and/or are used in the valuation.

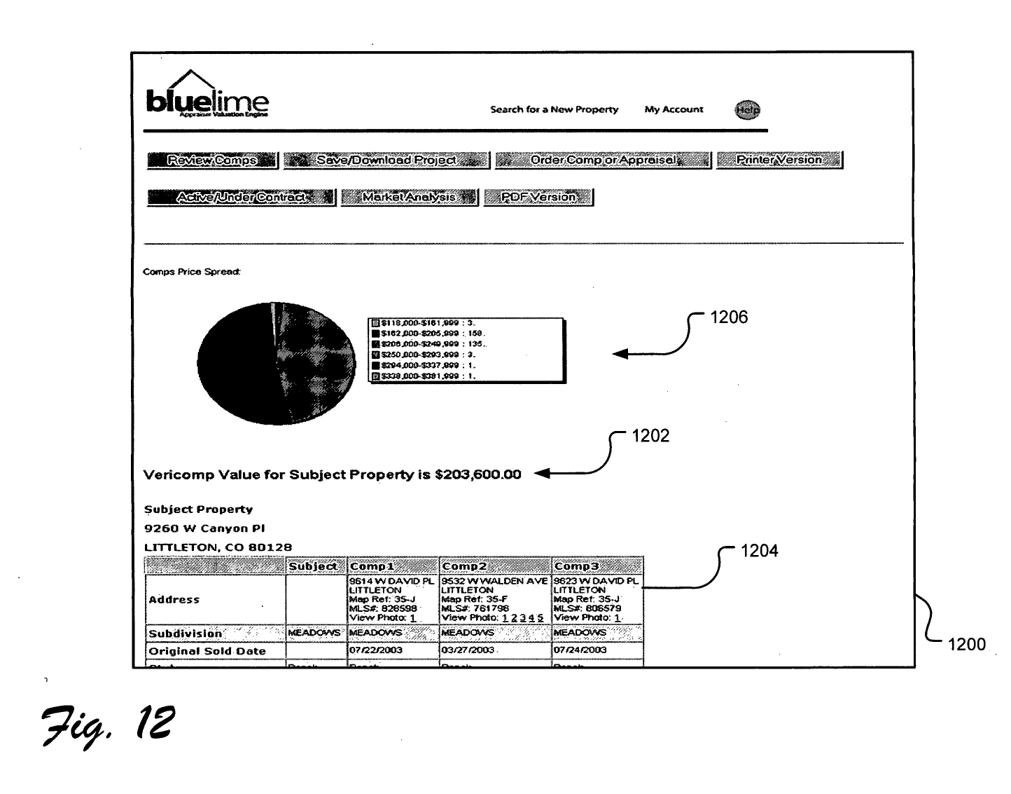

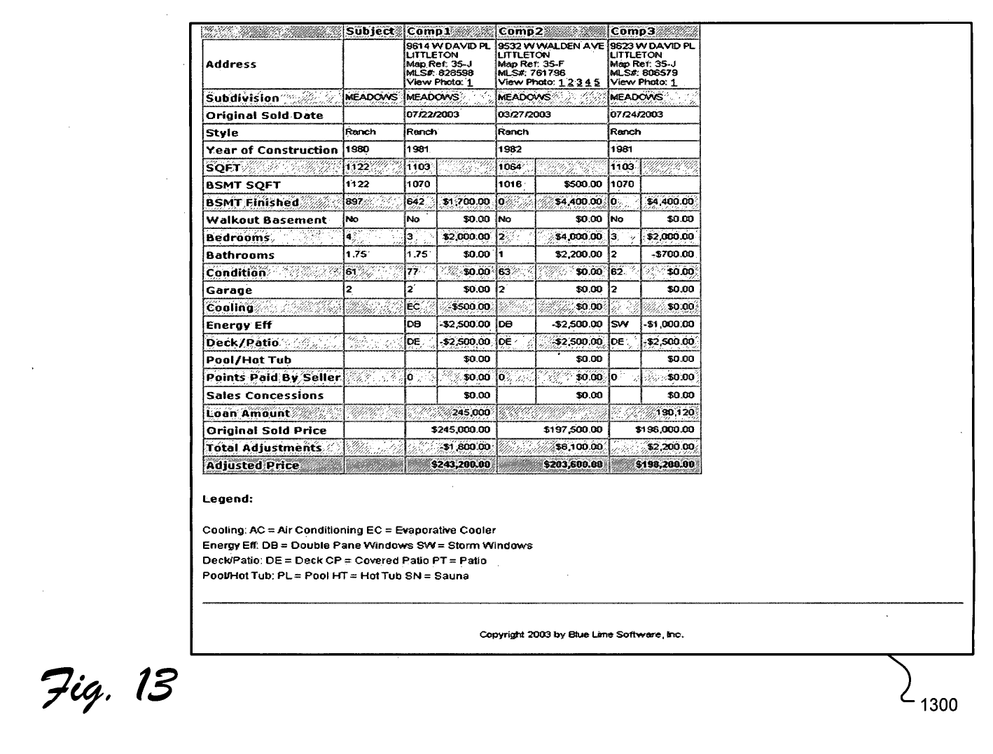

FIGS. 12 and 13 illustrate portions 1200 and 1300 of an estimated value page of an exemplary appraiser valuation engine. The estimated value page 1200 shows an estimated value 1202 of the subject property based on the comparable properties selected in the comparable pages shown in FIGS. 8-11. A comparable property summary table 1204 summarizes various property attributes, conditions, amenities, selling prices, and the like, which were analyzed in deriving the estimated value 1202. A comparable property price distribution graph 1206 illustrates ranges of prices of comparable properties and the proportions of the number of comparable properties in those ranges.

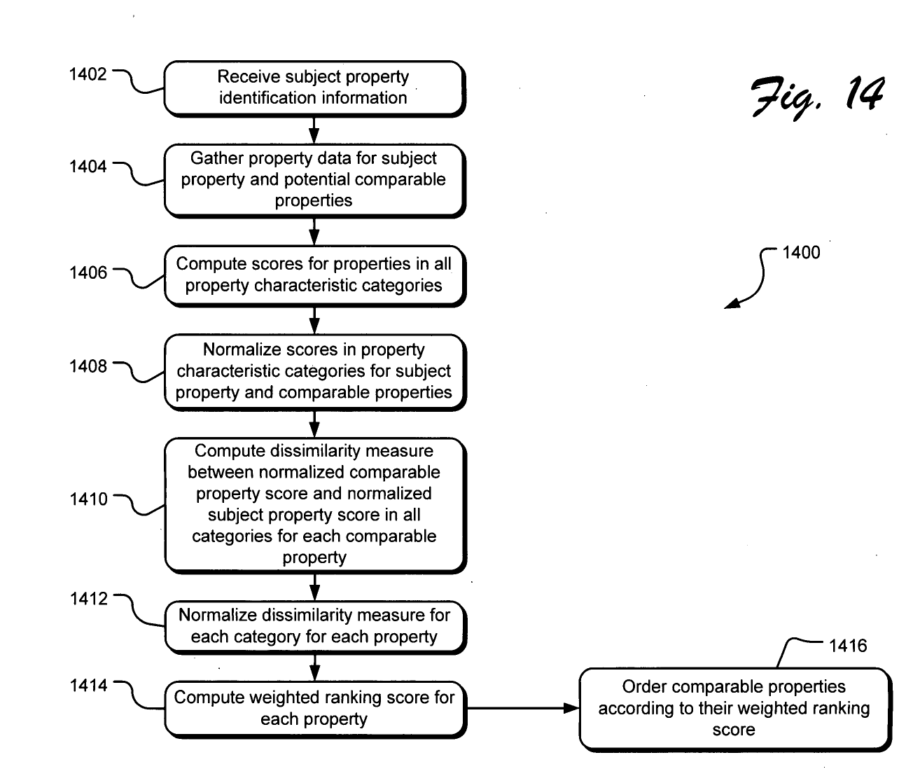

FIG. 14 illustrates operations 1400 of an exemplary appraiser valuation engine. A receiving operation 1402 receives identification of a subject property (e.g., address information) and identifies an initial set of comparable properties (e.g., based on rough parameters, such as location and style). A gathering operation 1404 collects property data about the subject property and the set of comparable properties from various sources, including an appraisal system database, an MLS database, a property tax database, etc. It should be understood that the property data for the comparable properties may be collected in advanced and stored in the appraisal system database, or may be collected from the various sources in response to receipt of the subject property identification.

A scoring operation 1406 computes characteristic scores for the identified properties (i.e., the subject property and the comparable properties) in multiple property characteristic categories. Exemplary property characteristic categories include square footage, style, number of bedrooms, and other categories shown in the comparable property data page. Other characteristic categories are also contemplated. For example, a score for the “number of bedrooms” characteristic may be the number of bedrooms itself. In contrast, the score for “style” may be a predefined schedule of scores associated with a range of property styles, such as “mobile homes”, “condominiums”, “duplexes”, “two stories”, “split levels”, and “ranges”, although other types of property styles may be employed. In an example for a “garage” characteristic, a score of ‘2’ is assigned if a property has an attached garage, a score of ‘1’ is assigned if the property has a detached garage, and a score of ‘0’ is assigned if the property has no garage. Furthermore, subjective characteristics may also be given a quantitative score. Also, for non-numerical fields, binary scoring may be employed (e.g., for a “garage” characteristic, a score of ‘1’ is assigned if a property has an attached garage, and a score of ‘0’ is assigned if it does not). In the scoring operation 1406, the mean and standard deviation of all values for each property characteristic category are also calculated.

A normalizing operation 1408 normalizes the scores for each property in each property characteristic category in order to facilitate processing and comparison of the scores for each property. In the following equations, i represents an index associated with the property characteristics and k represents an index associated with the K properties which are numbered 0 through (K−1). In one implementation, normalizing the comparable property scores is accomplished according to the following:

$${N}_{i , k} = \frac{( {s}_{i , k} - {\overline{s}}_{i} )}{{σ}_{i}}$$

where s_{i,k} represents the initial score for characteristic i and comparable property k, \overline{s}ᵢ represents the mean score for characteristic i, σᵢ represents the standard deviation of the scores for characteristic i, and N_{i,k} represents the normalized score for characteristic i and comparable property k. Likewise, normalizing the subject property scores is accomplished as follows:

$${N}_{i}^{0} = \frac{( {s}_{i}^{0} - {\overline{s}}_{i} )}{{σ}_{i}}$$

where sᵢ⁰ represents the initial score for characteristic i of the subject property, \overline{s}ᵢ represents the mean score for characteristic i, σᵢ represents the standard deviation of the scores for characteristic i, and Nᵢ⁰ represents the normalized score for characteristic i of the subject property.

A dissimilarity operation 1410 computes a dissimilarity measure, D, between each normalized comparable property score and the subject property score in each property characteristic category. In one implementation, the dissimilarity measure for each characteristic category of each comparable property is computed as follows:
D_{i,k}=(N_{i,k}−Nᵢ⁰)²
where D_{i,k} represents the dissimilarity measure of characteristic i and comparable property k.

Another normalizing operation 1412 normalizes each dissimilarity measure within a standard range. For example, to normalize a dissimilarity measure between 0 and 10, the following computation may be used:

$${D}_{i , k}^{*} = \frac{10 {D}_{i , k}}{{D}_{{i}_{max}}}$$

where Dᵢ_{ₘₐₓ} represents the maximum dissimilarity measure for a characteristic i across all comparable properties and D_{i,k}* represents the normalized dissimilarity measure for characteristic i and comparable property k.

When weighting of characteristics is enabled, a weighting operation 1414 computes a weighted ranking score for each comparable property across all of the property characteristics. An exemplary computation for each comparable property may be performed as follows:

$${R}_{k} = {\sum }_{m = 0}^{K - 1} ( \frac{{{w}_{i} ( {D}_{i , k}^{*} )}^{2}}{{\sum }_{n = 0}^{K - 1} {w}_{n}} )$$

where wᵢ represents the weighting factor for characteristic i, and Rₖ represents the weighted ranking score for comparable property k across all characteristics. If no weighting factors are employed, then wᵢ=1 for all i.

A ranking operation 1416 orders the comparable properties according to their weighted ranking score and displays the ranked comparable properties in the comparable property data page. The user may thereafter alter the selected comparables through the user interface, which is helpful to allow the user to incorporate the perceived influence of other factors known to the user, outside of the appraisal system (e.g., separation of a subject property

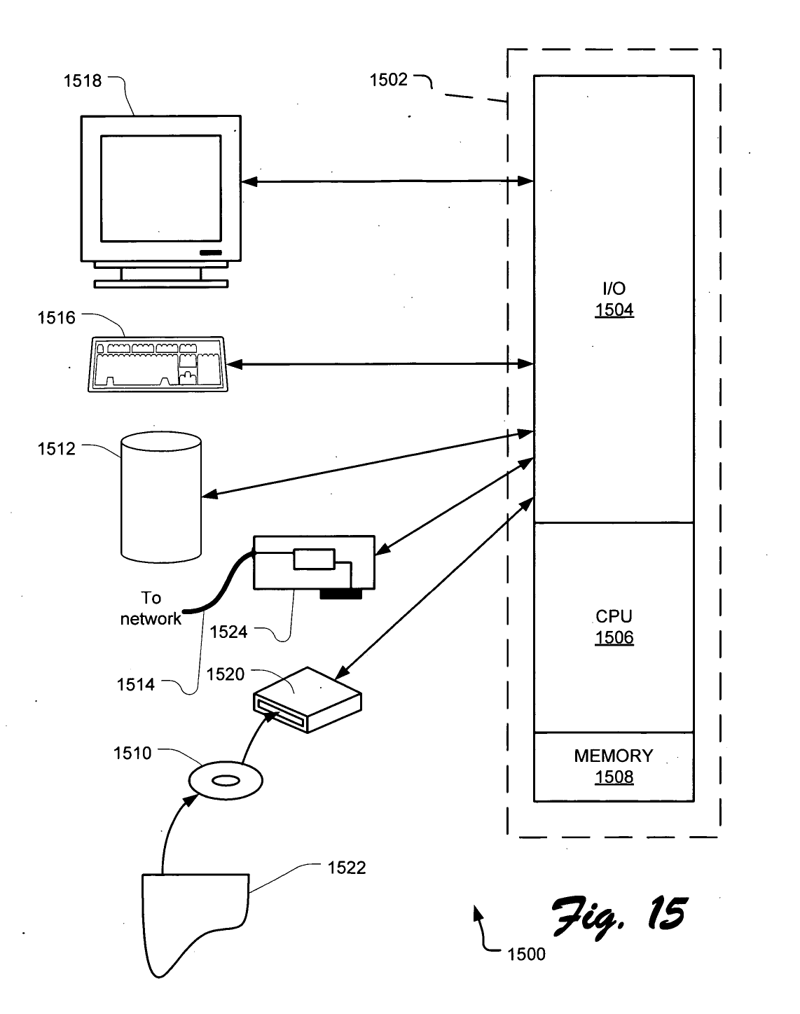

FIG. 15 illustrates an exemplary system useful in implementations of the described technology. A general purpose computer system 1500 is capable of executing a computer program product to execute a computer process. Data and program files may be input to the computer system 1500, which reads the files and executes the programs therein. Some of the elements of a general purpose computer system 1500 are shown in FIG. 15 wherein a processor 1502 is shown having an input/output (I/O) section 1504, a Central Processing Unit (CPU) 1506, and a memory section 1508. There may be one or more processors 1502, such that the processor 1502 of the computer system 1500 comprises a single central-processing unit 1506, or a plurality of processing units, commonly referred to as a parallel processing environment. The computer system 1500 may be a conventional computer, a distributed computer, or any other type of computer. The described technology is optionally implemented in software devices loaded in memory 1508, stored on a configured DVD/CD-ROM 1510 or storage unit 1512, and/or communicated via a wired or wireless network link 1514 on a carrier signal, thereby transforming the computer system 1500 in FIG. 15 to a special purpose machine for implementing the described operations.

The I/O section 1504 is connected to one or more user-interface devices (e.g., a keyboard 1516 and a display unit 1518), a disk storage unit 1512, and a disk drive unit 1520. Generally, in contemporary systems, the disk drive unit 1520 is a DVD/CD-ROM drive unit capable of reading the DVD/CD-ROM medium 1510, which typically contains programs and data 1522. Computer program products containing mechanisms to effectuate the systems and methods in accordance with the described technology may reside in the memory section 1504, on a disk storage unit 1512, or on the DVD/CD-ROM medium 1510 of such a system 1500. Alternatively, a disk drive unit 1520 may be replaced or supplemented by a floppy drive unit, a tape drive unit, or other storage medium drive unit. The network adapter 1524 is capable of connecting the computer system to a network via the network link 1514, through which the computer system can receive instructions and data embodied in a carrier wave. Examples of such systems include SPARC systems offered by Sun Microsystems, Inc., personal computers offered by Dell Corporation and by other manufacturers of Intel-compatible personal computers, PowerPC-based computing systems, ARM-based computing systems and other systems running a UNIX-based or other operating system. It should be understood that computing systems may also embody devices such as Personal Digital Assistants (PDAs), mobile phones, gaming consoles, set top boxes, etc.

When used in a LAN-networking environment, the computer system 1500 is connected (by wired connection or wirelessly) to a local network through the network interface or adapter 1524, which is one type of communications device. When used in a WAN-networking environment, the computer system 1500 typically includes a modem, a network adapter, or any other type of communications device for establishing communications over the wide area network. In a networked environment, program modules depicted relative to the computer system 1500 or portions thereof, may be stored in a remote memory storage device. It is appreciated that the network connections shown are exemplary and other means of and communications devices for establishing a communications link between the computers may be used.

In accordance with an implementation, software instructions directed toward determining rankings for comparable properties may be stored on disk storage unit 1509, disk drive unit 1507 or other storage medium units coupled to the system. Said software instructions may also be executed by CPU 1506.

The embodiments of the invention described herein are implemented as logical steps in one or more computer systems. The logical operations of the present invention are implemented (1) as a sequence of processor-implemented steps executing in one or more computer systems and (2) as interconnected machine or circuit modules within one or more computer systems. The implementation is a matter of choice, dependent on the performance requirements of the computer system implementing the invention. Accordingly, the logical operations making up the embodiments of the invention described herein are referred to variously as operations, steps, objects, or modules. Furthermore, it should be understood that logical operations may be performed in any order, unless explicitly claimed otherwise or a specific order is inherently necessitated by the claim language.

“Communication media” typically embodies computer-readable instructions, data structures, program modules, or other data in a modulated data signal, such as carrier wave or other transport mechanism. Communication media also includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above are also included within the scope of computer-readable media.

The above specification, examples and data provide a complete description of the structure and use of exemplary embodiments of the invention. Since many embodiments of the invention can be made without departing from the spirit and scope of the invention, the invention resides in the claims hereinafter appended.

1. A computer program product encoding a computer program that executes a computer process for ranking a plurality of comparable real estate properties relative to a subject real estate property in an appraisal process, the computer process comprising:
receiving scores associated with characteristic categories of the subject real estate property and of each comparable real estate property;
computing a dissimilarity measure in each characteristic category for each comparable real estate property;
aggregating the dissimilarity measures associated with individual comparable real estate property to generate a ranking score associated with the comparable real estate property; and
ordering the comparable real estate properties according to the ranking scores of the comparable real estate properties.

2. The computer program product of claim 1 wherein the computer process further comprises:
normalizing each score associated with a characteristic category and a comparable real estate property relative to others scores associated with the characteristic category.

3. The computer program product of claim 1 wherein the computer process further comprises:
normalizing the dissimilarity measures associated with a characteristic category relative to the maximum dissimilarity measure associated with the characteristic category.

4. The computer program product of claim 1 wherein the aggregating operation comprises:
applying a weighting factor to one or more dissimilarity measures; and
summing the dissimilarity measures for each comparable real estate property to generate the ranking score.

5. The computer program product of claim 1 wherein the operation of computing a dissimilarity measure comprises:
computing the dissimilarity measure between the score of the subject real estate property and the score of an individual comparable real estate property.

6. The computer program product of claim 1 wherein the operation of computing a dissimilarity measure comprises:
normalizing each score associated with a characteristic category and a comparable real estate property relative to others scores associated with the characteristic category;
normalizing each score associated with a characteristic category and the subject real estate property relative to others scores associated with the characteristic category; and
computing the dissimilarity measure between the normalized score of the subject real estate property and the normalized score of an individual comparable real estate property.

7. A method of ranking a plurality of comparable real estate properties relative to a subject real estate property in an appraisal process, the method comprising:
receiving scores associated with characteristic categories of the subject real estate property and of each comparable real estate property;
computing a dissimilarity measure in each characteristic category for each comparable real estate property;
aggregating the dissimilarity measures associated with individual comparable real estate property to generate a ranking score associated with the comparable real estate property; and
ordering the comparable real estate properties according to the ranking scores of the comparable real estate properties.

8. The method of claim 7 further comprising:
normalizing each score associated with a characteristic category and a comparable real estate property relative to others scores associated with the characteristic category.

9. The method of claim 7 further comprising:
normalizing the dissimilarity measures associated with a characteristic category relative to the maximum dissimilarity measure associated with the characteristic category.

10. The method of claim 7 wherein the aggregating operation comprises:
applying a weighting factor to one or more dissimilarity measures; and
summing the dissimilarity measures for each comparable real estate property to generate the ranking score.

11. The method of claim 7 wherein the operation of computing a dissimilarity measure comprises:
computing the dissimilarity measure between the score of the subject real estate property and the score of an individual comparable real estate property.

12. The method of claim 7 wherein the operation of computing a dissimilarity measure comprises:
normalizing each score associated with a characteristic category and a comparable real estate property relative to others scores associated with the characteristic category;
normalizing each score associated with a characteristic category and the subject real estate property relative to others scores associated with the characteristic category; and
computing the dissimilarity measure between the normalized score of the subject real estate property and the normalized score of an individual comparable real estate property.

13. A system for ranking a plurality of comparable real estate properties relative to a subject real estate property in an appraisal process, the system comprising:
means for receiving scores associated with characteristic categories of the subject real estate property and of each comparable real estate property;
means for computing a dissimilarity measure in each characteristic category for each comparable real estate property;
means for aggregating the dissimilarity measures associated with individual comparable real estate property to generate a ranking score associated with the comparable real estate property; and
means for ordering the comparable real estate properties according to the ranking scores of the comparable real estate properties.

14. The system of claim 13 further comprising:
means for normalizing each score associated with a characteristic category and a comparable real estate property relative to others scores associated with the characteristic category.

15. The system of claim 13 further comprising:
means for normalizing the dissimilarity measures associated with a characteristic category relative to the maximum dissimilarity measure associated with the characteristic category.

16. The system of claim 13 wherein the means for aggregating comprises:
means for applying a weighting factor to one or more dissimilarity measures; and
means for summing the dissimilarity measures for each comparable real estate property to generate the ranking score.

17. The system of claim 13 wherein the means for computing a dissimilarity measure comprises:
means for computing the dissimilarity measure between the score of the subject real estate property and the score of an individual comparable real estate property.

18. The system of claim 13 wherein the means for computing a dissimilarity measure comprise:
means for normalizing each score associated with a characteristic category and a comparable real estate property relative to others scores associated with the characteristic category;
means for normalizing each score associated with a characteristic category and the subject real estate property relative to others scores associated with the characteristic category; and;
means for computing the dissimilarity measure between the normalized score of the subject real estate property and the normalized score of an individual comparable real estate property.

19. A system for ranking a plurality of comparable real estate properties relative to a subject real estate property in an appraisal process, the system comprising:
a database that receives real estate property data relating to the comparable real estate properties; and
a scoring module that computes scores associated with characteristic categories of the subject real estate property and of each comparable real estate property based on the real estate property data received by the database;
a dissimilarity module that computes a dissimilarity measure in each characteristic category for each comparable real estate property;
an aggregation module that combines the dissimilarity measures associated with individual comparable real estate property to generate a ranking score associated with the comparable real estate property; and
a ranking module that orders the comparable real estate properties according to the ranking scores of the comparable real estate properties.

20. The system of claim 19 wherein the dissimilarity module comprises:
a first normalization module that normalizes each score associated with a characteristic category and a comparable real estate property relative to others scores associated with the characteristic category;
a second normalization module that normalizes each score associated with a characteristic category and the subject real estate property relative to others scores associated with the characteristic category, wherein the dissimilarity module computes the dissimilarity measure between the normalized score of the subject real estate property and the normalized score of an individual comparable real estate property.
